(19) United States
(12) Patent Application Publication
(10) Pub. No.: US 2005/0239545 A1
(43) Pub. Date: Oct. 27, 2005

(54) Programmatic control of gaming devices

(76) Inventor: Bruce Rowe, Henderson, NV (US)

Correspondence Address: FENWICK & WEST LLP, SILICON VALLEY CENTER, 801 CALIFORNIA STREET, MOUNTAIN VIEW, CA, 94041, US

(21) Appl. No.: 10/891,419

(22) Filed: Jul. 13, 2004

Related U.S. Application Data
(60) Provisional application No. 60/487,147, filed on Jul. 14, 2003.

(51) Int. Cl. A63F 13/00

(52) U.S. Cl. 463/29

(57) ABSTRACT

An event controller is provided for programmatic control of gaming devices. The event controller includes operating modes for adjusting game parameters, distributing audio and video, adjusting casino floor lighting, and performing auxiliary control functions. A gaming devices management system communicates control commands to the gaming devices. The control commands can adjust, for example, the audio volume of the gaming device. A rules database can be configured to provide programmable event processing. The rules database includes expressions that conditionally activate a particular event. The event controller can control the gaming devices in response to signals from a life safety system, for example, to reduce the audio volume of the gaming devices in the event of an emergency.

### CROSS REFERENCE TO RELATED APPLICATION

This application claims the benefit of under U.S.C. section 119(e) from U.S. Patent Application Ser. No. 60/487,147, entitled “Programmatic Control of Gaming Devices” by Bruce C. Rowe, filed Jul. 14, 2003, which is incorporated by reference in its entirety.

### TECHNICAL FIELD

This invention relates generally to control systems and, more particularly, to management and to marketing of gaming devices.

### BACKGROUND

Modern casinos may have several thousand electronic gaming devices. A casino floor generally includes a variety of game models and themes to attract and to entertain players. Electronic gaming devices generate music, game-related sounds, flashy video displays, and colorful lighting to provide lively, interactive game play. The casino floor vibrates in a maelstrom of ringing bells, jangling coins, television or movie theme songs, and exhortations of “Come on Down!”, “Wheel of Fortune!”, or “Let's Play Slotto!” Each of the several thousand gaming devices is an independent source of sound that competes for a player's attention. In addition to the sound created by electronic gaming devices, casinos typically have background music and paging systems, live bands, and discordant sound created by customers and employees. The combination of sounds fills the casino environment with a cacophony of noise.

Manufacturers of electronic gaming devices typically set a machine's volume level quite loud because casinos are noisy environments and manufacturers want to attract attention to their machine. The volume level of a typical machine is set based on the assumption of a highly active casino floor with many nearby games. Thus, the manufacturer sets the machine loud enough to be heard in a considerably noisy environment. In some cases, a gaming device's volume level can be manually adjusted at the time the game is installed or during maintenance (when the game is not being operated by a patron). In other cases, the device's volume level is fixed by the manufacturer. In neither case, can a casino operator easily control the sound level of several thousand devices while they are being used to create the desired environment. At best the operator manually adjust individual machines when the machines are out of service. The casino operator cannot adapt the aggregate sound level to satisfy customer service needs or marketing goals. Currently, marketing decisions are often limited to positioning and grouping the gaming devices on the casino floor, depending on the type of gaming device.

The unconstrained noise present in casino environments contributes to a number of customer relationship problems. For example, customers find it difficult to summon an employee for assistance if the employee cannot hear the customer's request. Customers cannot easily use their cellular phones or other audio devices in a noisy environment. Further, customers find it difficult to hear paging announcements or enjoy the background music.

Further, a noisy environment may represent a significant risk to life and to property in an emergency situation. Conventionally, gaming devices have not been connected to or interfaced with a building's life safety system. The noise from the gaming devices can prevent building occupants from hearing important life safety messages or sirens. Even when aggregate noise levels are not excessively high, the composition of the sound makes it difficult for one to distinguish a life safety alert from regular casino sounds. For example, slot machines routinely produce various rings, dings, and other sounds of celebration when the machine hits a jackpot, sounds that make it difficult for a patron to hear true emergency sirens or alarms. A true alarm or siren could be easily ignored by patrons, who mistake it for just another sound on the casino floor.

What is therefore needed is a system that: (1) interfaces gaming devices with a life safety system; (2) provides flexible marketing and customer service controls; and (3) provides programmatic control over aspects of gaming device operation.

### SUMMARY OF THE INVENTION

In embodiments of the present invention, an event controller provides control over gaming device functions or casino operations. The event controller integrates system entities into an configuration of programmable control, and responds to signals and messages from the system entities in order to control the operation of the gaming devices and other system entities. The event controller can control the gaming devices either individually, by type, group, location, or other characteristics.

For example, a life safety system can send an event message to the event controller indicating that a fire alarm has been activated. The event controller can then send a control command to various gaming devices to instruct the gaming devices to mute their audio outputs. The casino customers will then be able to more easily hear the fire alarm and instructions on how to respond to the alarm or the alarm itself when the gaming devices have been silenced. The event controller can also send control commands to the gaming devices to output video content on the video displays of the gaming devices, for example, text or video instructing the patrons how to safely leave the casino. In this capacity the event controller provides a beneficial way of controlling the gaming devices for life safety purposes.

The event controller also provides control over other aspects of the gaming device or casino operation. In one embodiment, rules-based event processing is provided. The event controller generally operates by detecting event messages on one of its input ports. Depending on the event message received, the event controller generates a control command and sends the control command to an interface of a system entity. The event controller can evaluate an expression to determine how to process the event message. For example, a gaming devices management system can send an event message to the event controller that indicates that a patron has hit a jackpot on a particular gaming device. The event controller can apply a rule that when a jackpot message is received, a control command is sent to the music and paging system to play a special message to the casino patrons. As another example, a sensor in the casino can provide to the event controller a signal indicative of the ambient or background noise level. The event controller can use this information to adjust the volume of the gaming devices with respect to the background noise level. Therefore, the audio output of the gaming devices can be made responsive to the level of background noise. In this capacity, the event controller provides a beneficial way of controlling the gaming devices for marketing, hospitality, or other patron experience-related purposes.

In another embodiment of the present invention, schedule-based event processing is provided. For example, at 06:00 hours each weekday the event controller can send a control command to the gaming devices to adjust the volume of the audio outputs. Any number of scheduled commands may be implemented to control the gaming devices. This schedule-based control capability further extends the life safety and experience-related uses of the event controller.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

The accompanying drawings, which are incorporated in and constitute a part of this specification, illustrate several embodiments of the invention and, together with the description, serve to explain the principles of the invention.

FIG. 1 is a block diagram illustrating a system configuration for programmatic control of gaming devices according to one embodiment of the present invention.

FIG. 2 is a block diagram illustrating a system configuration for programmatic control of gaming devices according to another embodiment of the present invention.

FIG. 3 is a block diagram illustrating a system configuration for programmatic control of gaming devices according to a further embodiment of the present invention.

FIG. 4 is a data flow diagram for an event controller according to one embodiment of the present invention.

FIG. 5 is a block diagram of an event controller according to one embodiment of the present invention.

FIG. 6 is a block diagram of an event controller according to another embodiment of the present invention.

FIG. 7 is a block diagram of a game board according to one embodiment of the present invention.

FIG. 8 is block diagram illustrating an audio processing unit of a game board according to one embodiment of the present invention.

FIG. 9 is a block diagram illustrating a video processing unit of a game board according to one embodiment of the present invention.

FIG. 10 is an illustration of a data structure in a transport stream according to one embodiment of the present invention.

FIG. 11 is a flowchart illustrating event processing according to one embodiment of the present invention.

FIG. 12 is a flowchart illustrating further details of detecting an inbound signal 1110 according to one embodiment of the present invention.

FIG. 13 is a flowchart illustrating further details of evaluating an event message 1122 according to one embodiment of the present invention.

FIG. 14 is a diagram of an exemplary event configuration user interface according to one embodiment of the present invention.

FIG. 15 is a diagram of an exemplary message announcement user interface according to one embodiment of the present invention.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE EMBODIMENTS

The present invention is now described more fully with reference to the accompanying figures, in which several embodiments of the invention are shown.

A. System Architectures

1. First System Configuration

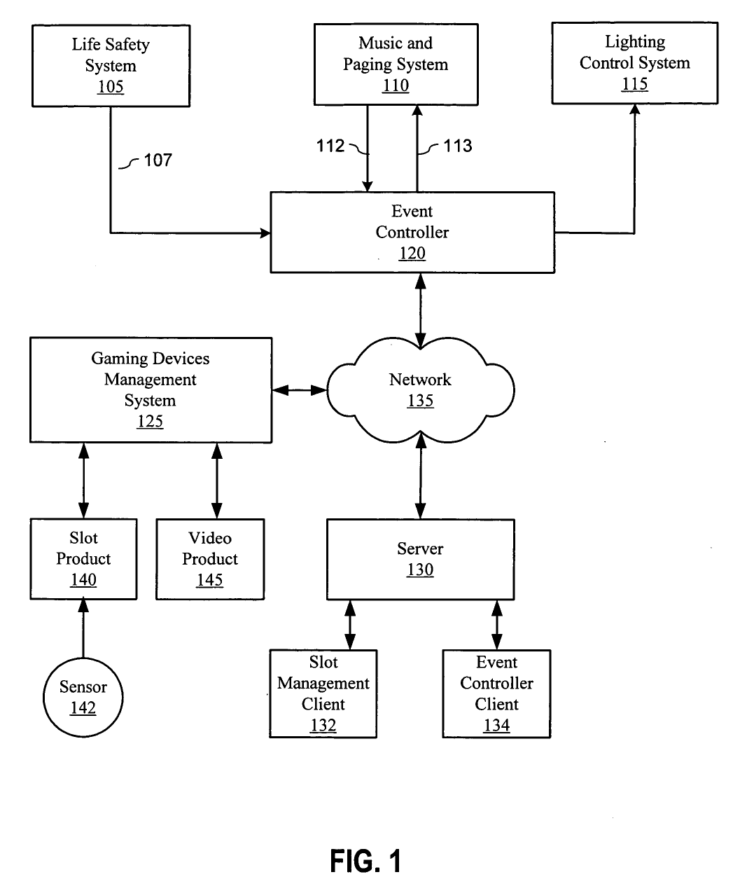

FIG. 1 is a block diagram illustrating a system configuration for programmatic control of gaming devices according to one embodiment of the present invention. In general, embodiments of the present invention operate in a casino, a gaming establishment, or similar facilities having a plurality of gaming devices. In the illustrated embodiment, a life safety system 105, a music and paging system 110, and a lighting control system 115 are coupled to an event controller 120. The life safety system 105 is coupled to the event controller 120 via an alarm output 107. The event controller 120, a gaming devices management system 125, and a server 130 are each coupled to a network 135. The gaming devices management system 125 is coupled to gaming devices such as slot products 140 and video products 145. A sensor 142 is coupled to the slot product 140. A slot management client 132 and an event controller client 134 are illustrated coupled to the server 130. The slot management client 132 and the event controller client 134 communicate with the server 130. The server 130 communicates with the event controller 120 across network 135. The server 130 also communicates with the gaming devices management system 125 across network 135. One skilled in the art will recognize that the terms “coupled” or “coupling” as used herein are not limited to wireline electrical connections. A wireless connection, for example, can couple the event controller 120 to the network 135.

In one embodiment, the network 135 is a private network, such as a switched Ethernet network using conventional networking protocols and hardware. The network 135 can also be partially public or wholly public network such as the Internet. Security procedures such as Virtual Private Networking (VPN) or Internet Protocol Security (IPsec) can be used to maintain privacy on a public infrastructure or to increase security on a private infrastructure. Although each of the event controller 120, the gaming devices management system 125, and server 130 are singularly illustrated in FIG. 1, multiple instances of each can be deployed. For example, the network 135 can span several physically distinct casino properties. One or more event controllers 120 can be implemented in each of the properties and coupled to the network 135. Similarly, one or more gaming device management systems 125 or servers 130 can be coupled to the network 130. In addition, the event controller 120 can be directly coupled to another entity, such as the gaming devices management system 125, without communicating across the network 130.

The gaming devices management system 125 collects and processes data about the gaming devices, illustrated here as slot product 140 and the video product 145. In one embodiment of the present invention, the gaming devices management system 125 is a Slot Data System that is commercially available from Bally Gaming and Systems, Las Vegas, Nev., though any other comparable casino management and accounting system may also be used. While only a single slot product 140 and video product 145 are illustrated, it is understood that there will in practice be many such gaming devices (hundreds or thousands) on the casino floor, of varying types, in various functional and/or geographic groupings. Slot product 140 and video product 145 are each networked and interfaced with the gaming devices management system 125. One skilled in the art will appreciate that the slot and video products 140,145 (collectively gaming devices) are referred to below in the singular for clarity of explanation.

In the illustrated embodiment, the server 130 can be used to configure or to control the event controller 120. The event controller client 134 provides, for example, a user interface through which a user can configure or monitor the event controller 120. Similarly, a user can configure or monitor the gaming devices management system 125 through an interface on the slot management client 132. The server 130 can be a conventional computing device. Example devices include mainframes (e.g., a eServer zSeries 900, commercially available from International Business Machines Corp., Armonk, N.Y.), enterprise servers (e.g., a Sun Fire 15K Server, commercially available from Sun Microsystems, Inc., Santa Clara, Calif.), application servers, workstations, personal computers, and network computers.

The sensor 142 can be a conventional microphone or other sensor used to detect environmental conditions in the gaming facility. In the illustrated embodiment, the sensor 142 is coupled proximate to a slot product 140 or video product 145. The sensor 142 can be integrated into the cabinet of the slot product 140 or placed nearby, such as overhead (e.g., suspended from the ceiling). One type of environmental condition that the sensor 142 detects is the ambient sound level present proximate to the sensor 142. Data from the sensor 142 can be captured by a data acquisition device and stored in, for example, the server 130. One skilled in the art will appreciate that the sensor 142 can be configured to detect other environmental conditions or to detect conditions using multiple technologies such as using one or both of infrared and radar to detect the presence of people or movement in the facility.

Although the event controller 120 is illustrated in FIG. 1 for example as a distinct entity, one skilled in the art will recognize that the features or functions of the event controller 120 can be integrated into other system entities. For example, the gaming devices management system 125 can be configured or modified to include some or all of the features or functions described herein with reference to the event controller 120. Therefore, as one skilled in the art will appreciate, the present invention can be implemented with a variety of system entities and in many configurations.

In the exemplary system configuration illustrated in FIG. 1, the event controller 120 is coupled to several system entities. The event controller 120 provides flexibility in terms of its interfaces and system couplings. One skilled in the art will appreciate that the event controller 120 can implement various features and functionalities depending on its couplings to the system entities. In one example configuration of the present invention, the event controller 120 is coupled only to the life safety system 105. Further exemplary details of features, interfaces, and system configurations are described below.

2. System Function

The system architecture of the present invention is capable of providing programmatic control over aspects of gaming device operation or casino operations. The event controller 120 enables a functional integration of a plurality of devices by asynchronously receiving and processing events. For example, with reference to FIG. 1, the event controller 120 can be integrated with the life safety system 105 to perform tasks responsive to a life safety event. The event controller 120 can be integrated with the music and paging system 110 for distributing audio/video to or from the gaming devices. The event controller 120 can be integrated with the gaming devices management system 125 for adjusting game parameters. And the event controller 120 can be integrated with the lighting control system 115 for adjusting lighting parameters.

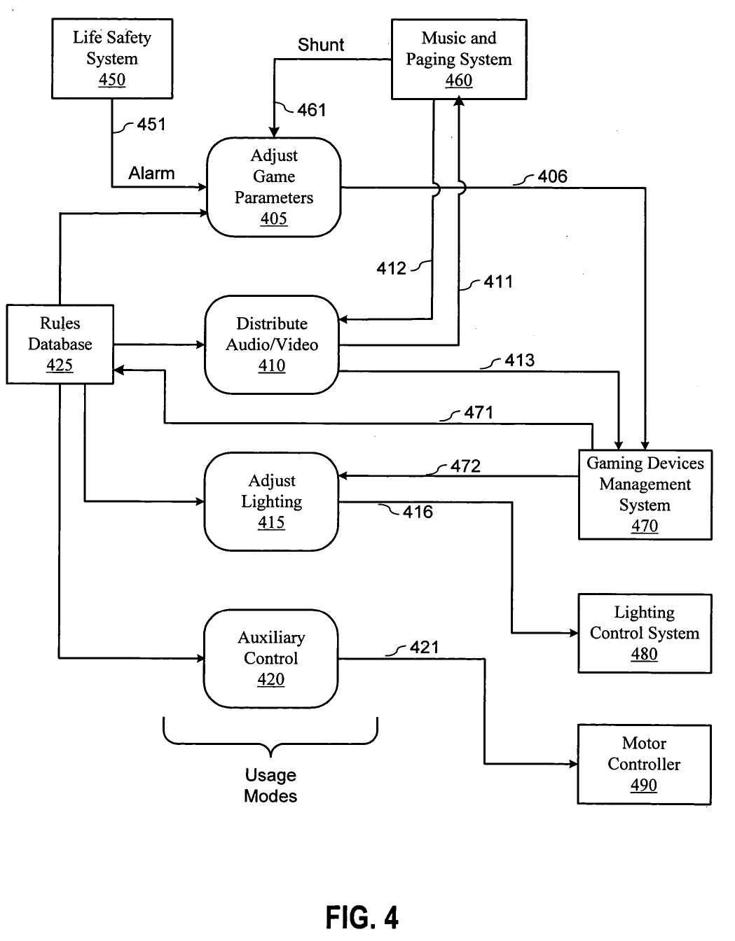

As described in additional detail below and with reference to FIG. 4, the event controller 120 includes a plurality of ports for processing multiple events concurrently. For example, the sending and receiving of data (including event messages) from the network 130 does not block the plurality of ports. Further, flow control mechanisms and buffers can be used to ensure non-blocking event processing. System function is now further described using several examples or operational modes for clarity of illustration.

a) Interactive Mode

In one embodiment, the server 130 is the source of the programmatic control and the event controller 120 interacts with the server 130. That is, the event controller 120 functions as a signal interface for the server 130. The event controller 120 communicates the event message to the server 130. The server 130 evaluates the event message and sends instructions to the event controller 120. The event controller 120 then performs the instructions by generating a control command or sequence of control commands on an output port to activate an event. In this embodiment, the server 130 is configured with information about the event message and operation of the event controller 120 responsive to the event message.

In another embodiment, the server 130 can generate an event message and send the event message to the event controller 120. That is, the server 130 may instruct the event controller 120 to perform a set of tasks at a particular time. This type of event message is a schedule-based event message. The server 130 can include a calendaring function that generates event messages at particular times. For example, during non-peak hours in a casino facility, the server 130 can generate an event message for the event controller 120 to adjust the audio volume of the gaming devices. One reason for doing this is that there is typically less background noise during non-peak hours because fewer patrons are present.

An example event using the system configuration described above and with reference to FIG. 1 includes activating a spotlight on a patron operating the slot product 140 when the slot product 140 hits a jackpot. The gaming devices management system 125 acquires data about the operation of the slot product 140. When the slot product 140 hits a jackpot, the slot product 140 informs the gaming devices management system 125 that a jackpot occurred. The gaming device management system 125 sends a corresponding event message to the event controller 120. The event controller 120 receives the event message and communicates with the server 130 to determine how to process the event message and whether to activate some device or other output in response thereto. Generally, activation of an output includes the deactivation of an output as well. The server 130 instructs the event controller 120 to send a control command to the lighting control system 115. The lighting control system 115 receives the control command and illuminates the patron operating the slot product 140. The control command includes fields for specifying the location of the slot product 140 and the time duration of the spotlight. Alternatively, based on other criteria (such as time duration), the event controller 120 can send a second control command to the lighting control system 115 to deactivate the spotlight.

b) Standalone Mode

In another embodiment, the event controller 120 is configured to receive event messages and generate control commands without interaction with the server 130 or the event controller client 134. Although the server 130 or the event controller client 134 can be used to configure the event controller 120, the event controller 120 can store control commands or expressions internally and does not rely on these entities 130, 134 in operation. When an event message is received, the event controller 120 can evaluate the event message and generate a corresponding control command. In standalone mode, therefore, the functionality of event message evaluation is included in the event controller 120, rather than being distributed or shared with another system entity such as the server 130.

The event controller 120 provides beneficial features in the event of a life safety emergency (e.g., a fire, a natural disaster, or an act of terrorism). The life safety system 105 is a system that detects the occurrence of a life safety emergency event. When a life safety emergency occurs, the life safety system 105 asserts a signal on the alarm output 107. The asserted signal can be, for example, a voltage level change or an encoded message using a conventional encoding technique. An encoded message or bi-directional communications protocol is less prone to false activation as one skilled in the art will appreciate. The event controller 120 can then stop the operation of the gaming devices 140, 145 or selectively mute their volume, so that patrons can hear an alarm or emergency announcement. The event controller 120 can optionally use the display screens of a video product 145 to display an emergency message to the patron.

In a standalone operating mode, the event controller 120 receives the event message from the life safety system 105 on an input port and generates a control command. The control command includes an interrupt signal that is sent to the gaming devices management system 125. The gaming devices management system 125 forwards the interrupt signal to the gaming devices (e.g., the slot and video product 140, 145). The gaming devices accordingly mute their audio outputs so that the patrons can hear a public address or siren, for example.

In one embodiment of the present invention, the event controller 120 performs tasks such as sending control commands responsive to an event message. The event message is received from a system entity such as the gaming devices management system 125. In another embodiment of the present invention, the event controller 120 can generate an event message, such as a schedule-based event message. For example, the event controller 120 can be configured to activate a gaming device volume control event at a particular time of day. The event controller 120 can be configured to evaluate an expression or a rule that defines a set of conditions for activating an event. When an event is activated, a control command or set of control commands is sent to one or more system entities. Expression evaluation is described further below.

c) Hybrid Mode

In a further embodiment of the present invention, the interactive and standalone modes described above are not mutually exclusive. That is, the event controller 120 can be configured to operate in a hybrid mode that concurrently operates in both interactive and standalone modes depending on the event message. For example, the event controller 120 can be configured to process a life safety event message in a standalone manner, while other events are processed in the interactive mode. One benefit of the hybrid mode is that critical events can be processed with less reliance on other system entities, while non-critical events can be more flexibly handled through the server 130. Therefore, even if the server 130 is temporarily unavailable, the event controller 120 can continue to process critical event messages without interruption.

3. Second System Configuration

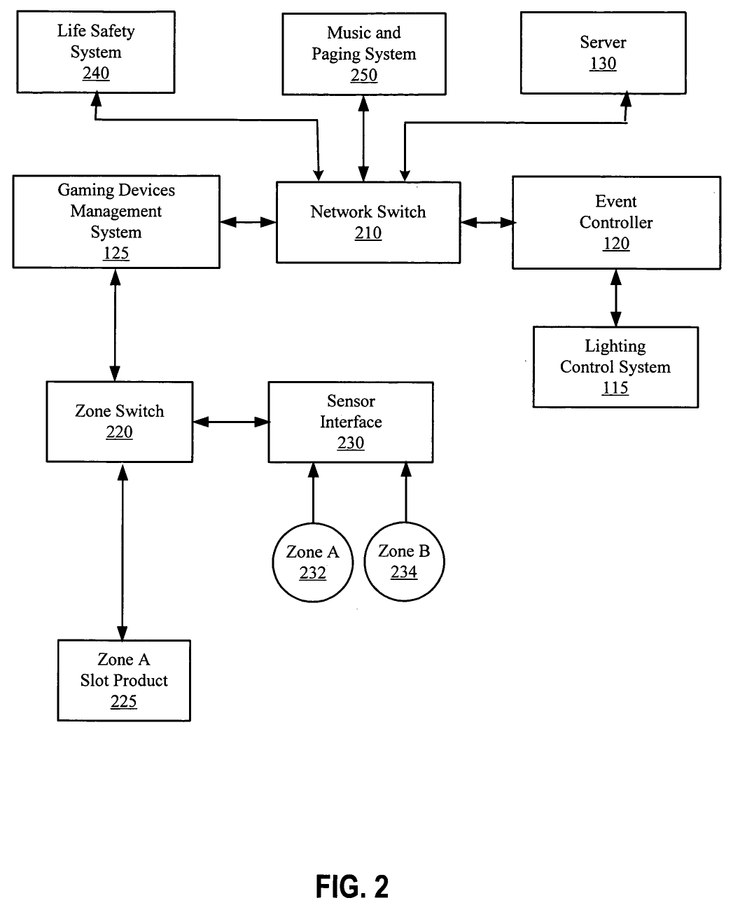

FIG. 2 is a block diagram illustrating a system configuration for programmatic control of gaming devices according to another embodiment of the present invention. In the illustrated embodiment, a life safety system 240, a music and paging system 250, the event controller 120, the gaming devices management system 125, and the server 130, and are coupled to a network switch 210. That is, each of these system entities interfaces and communicates with the network switch 210. In this configuration, the lighting control system 115 is coupled to the event controller 120.

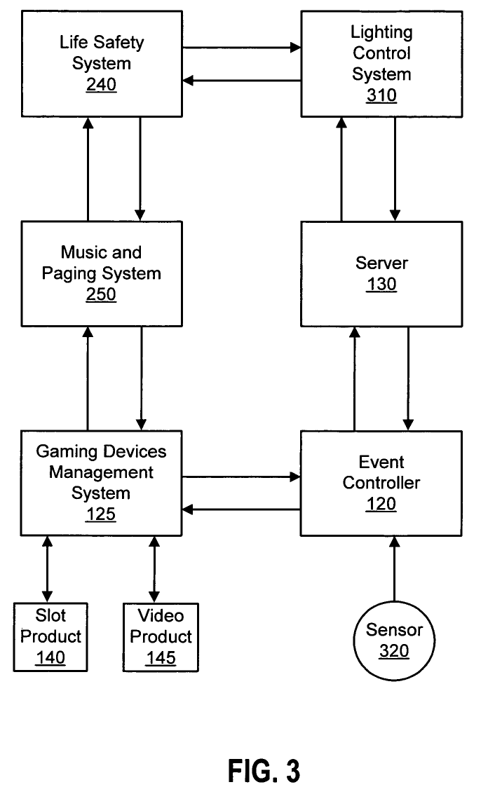

The system configuration illustrated in FIG. 2 is one example of a configuration where system entities, such as the life safety system 240, can interface with the network switch 210. One benefit of the illustrated configuration is simplified premises wiring. For example, the life safety system 240 is similar to the life safety system 105 (FIG. 1); however, the life safety system 240 includes a network interface for communicating event messages to the event controller 120. Although not specifically illustrated in FIG. 2, other system entities can be similarly configured to communicate via the network switch 210. For example, the lighting control system 115 can include a network interface (see, e.g., FIG. 3). One skilled in the art will recognize that a system entity can be coupled to the event controller 120 depending on the available interface of the system entity. For example, the music and paging system 250 represents a conventional public address system that includes a network interface for sending and receiving a digital media stream.

In one embodiment, the network switch 210 is a conventional Ethernet-based switch, such as a Catalyst 6500, commercially available from Cisco Systems, Inc., San Jose, Calif. In addition, the network switch 210 can support a configuration including a plurality of premises or a plurality of system entities similar to the network 135 described above. In one embodiment, the network switch 210 provides quality of service (QOS) features for optimizing packet switching or routing. The quality of service feature can be used, for example, to ensure that data from the life safety system 240 is directed to the event controller 120 without blocking in the network switch 210.

The illustrated embodiment also includes a zone switch 220 coupled to the gaming devices management system 125. A sensor interface 230 is coupled to the zone switch 220. A zone A sensor 232 and a zone B sensor 234 are each coupled to the sensor interface 230. The gaming devices can be physically cabled or logically grouped into zones. Zones can be used to group gaming devices according to various parameters including physical location and product type. For example, zone A slot product 225 can represent a bank of “Thrillions” progressive slot machines that are commercially available from Bally Gaming and Systems, Las Vegas, Nev.

4. Function of Zones

The system configuration of FIG. 2 includes some distributed functionality for obtaining data from the gaming devices and from sensors 232, 234. The zone switch 220 is a network switch for coupling a plurality of zones. The zone switch 220 is an example of the infrastructure that can be used to couple thousands of gaming devices to the gaming device management system 125. The zone switch 220 uplinks the data from, for example, zone A slot product 225 to the gaming devices management system 125. The zone switch 220 also uplinks the data from the sensor interface 230 to the gaming devices management system 125. In the illustrated embodiment, the sensor interface 230 provides an electrical coupling for a plurality of zone sensors 232, 234. The sensor interface 230 obtains signals from the sensors 232, 234 and sends these signals to the gaming device management system 125 via the zone switch 220. The sensor interface 230 provides a data path for sensor information that is distinct from the gaming devices. Therefore the sensors 232, 234 can be distributed within the environment without being directly coupled to the gaming devices as illustrated in FIG. 1, for example. In response to the data signals from the various zone sensors 232, 234, the event controller 120 can issue control commands to groups of gaming devices in the corresponding zone.

In one embodiment, the zone A sensor 232 detects environmental conditions for the gaming devices configured in zone A. Similarly, the zone B sensor 234 detects environmental conditions for the gaming devices configured in zone B. A plurality of zones can be coupled to the sensor interface 230. The zone sensors 232, 234 can be placed inside the cabinet of a gaming device or located in another area, such as the ceiling or floor. The zone sensors 232, 234 need not correspond, however, to particular gaming device zones. That is, the sensor interface 130 can obtain signals from a plurality of sensors regardless of whether the gaming devices are segmented into zones.

5. Third System Configuration

FIG. 3 is a block diagram illustrating a system configuration for programmatic control of gaming devices according to a further embodiment of the present invention. In the illustrated embodiment, each of the event controller 120, the gaming devices management system 125, the server 130, the life safety system 240, the music and paging system 250, and the lighting control system 310 are coupled in a ring topology. Benefits of the ring topology include point-to-point communications and accommodation of high throughput links. Advantages of point-to-point communication links include signal regeneration at each node and simple fault isolation. High throughout optical links can use, for example, asynchronous time-division multiplexing or a synchronous technique, such as synchronous optical networking (SONET). Multiplexing is desirable because the capacity of the transmission medium typically exceeds the bandwidth required to send a single communication (e.g., an event message from the gaming devices management system 125 to the event controller 120).

In the illustrated configuration, a sensor 320 is illustrated coupled to the event controller 120. Although the sensor 320 is singularly illustrated, embodiments of the event controller 120 can accommodate a plurality of sensors coupled thereto. One advantage of the illustrated configuration is less intrusiveness into a pre-existing building management system. In addition, legacy gaming devices can be accommodated that do not support auxiliary interfaces. More specifically, in this configuration, the gaming devices (e.g. the slot product 140) need not include an interface for the sensor 320. A single sensor 320 or a plurality of sensors can be distributed throughout the gaming facility. In an implementation of the present invention where a user (e.g., a casino operator) wishes to control gaming devices in discrete zones, a sensor can be placed proximate to each particular zone. Where gaming devices are not zoned by physical location, a plurality of sensors can be deployed and virtualized into the corresponding zones. That is, the event controller 120 can assign the sensor 320 to be a member of a particular zone or grouping regardless of its physical location or coupling to the event controller 120.

B. Event Controller Data Flow

FIG. 4 is a data flow diagram for an event controller according to one embodiment of the present invention. The data flow and system entity interactions are illustrated for four exemplary usage modes including: adjusting game parameters 405, distributing audio/video 410, adjusting lighting 415, and performing auxiliary control 420. Exemplary interactions with a life safety system 450, a music and paging system 460, a gaming devices management system 470, a lighting control system 480, and a motor controller 490 are illustrated for each of the usage modes. A rules database 425 provides a data store for conditional expressions that can be evaluated to determine how the event controller 120 responds to an event message. In the standalone operating mode described above, the functionality of the rules database 425 is included in the event controller 120. In the interactive operating mode described above, the functionality of the rules database 425 is included in the server 130. One skilled in the art will appreciate, however, that the system architecture of the present invention accommodates distributed functionality, such as in the hybrid operating mode described above. Therefore, portions of the rules database 425 can be distributed among various system entities including, for example, the event controller client 134. The exemplary usage modes shown in FIG. 4 are described in further detail below. The usage modes can operate independently. That is, if the event controller 120 is processing an event for a first usage mode, the event controller 120 continues to receive and to process event messages related to a second usage mode. Although the event controller 120 has non-blocking event handling, resources (e.g., memory bandwidth or read/write ports) can also be assigned to give priority to specific inputs (such as life safety system 450). In the following description, the term “path” refers to a communications channel, packet transmission, or other type of information signaling (e.g., data transmission across the network 125).

1. Adjusting Game Parameters

A gaming device includes several functional units, such as a presentation module, game logic module, and control module. The game logic module performs the random number generation and related processes that implement the game play features. The presentation module implements the user interface features of the gaming device. Some example aspects of the user interface include audio, video, lighting, and mechanical features such as a button panel or touchscreen. The control module interfaces and controls the game logic module and the presentation module. The control module also couples to and communicates with the gaming device management system. In one embodiment of the present invention, the event controller sends messages or control commands to the gaming device control module via the gaming device management system. Responsive to these control commands, the control module adjusts the game parameters. For example, the control commands can change the denomination of the game device, from a $0.25 denomination to a $1.00 denomination. This may be done dynamically in response to external events, or on a schedule basis. Other game parameters that may be adjusted include a hold percentage of a gaming machine, a pay table, or a game selection (e.g., in video products 145 having a plurality of different available games).

The audio volume level is one example of a presentation module feature that can be adjusted. An alarm signal 451 from the life safety system 450 activates an event to attenuate the audio output of one or more gaming devices. The alarm signal 451 indicates an active life safety alert. Responsive to the alarm signal 451, the event controller is configured to send a control command along path 406 to the gaming devices management system 470. The gaming device management system 470 then forwards the control command to one or more gaming devices. The control command includes instructions for the control module of the gaming device to attenuate the audio output. In one embodiment of the present invention, when the alarm signal 451 is no longer asserted, a second control command is sent along path 406 the gaming devices management system 470. The second control command includes instructions for resetting the audio output on the gaming device.

The music and paging system 460 can also cause an event that adjusts game parameters 405. In a noisy environment, it may be difficult for patrons to hear the music and paging system 460. A shunt signal 461 from the music and paging system 460 can activate an event to attenuate the audio output of one or more gaming devices while a page is being broadcast. Responsive to the shunt signal 461, the event controller is configured to send a control command 406 to the gaming devices management system 470. The gaming device management system 470 then forwards the control command to one or more gaming devices. The control command 406 includes instructions for the control module of the gaming device to attenuate the audio output. When the page is over, the music and paging system 460 can de-assert the shunt signal 461. This causes a reset event on the gaming devices.

In addition, the rules database 425 can activate an event that adjusts game parameters 405. The rules database 425 can be configured with a plurality of expressions and corresponding event messages. For example, the rules database 425 can receive an event message on path 471 from the gaming devices management system 470. In this example, the gaming devices management system 470 is configured to generate an event message periodically that contains the current utilization of the gaming devices in zone A. The rules database 425 includes an expression such as “if the zone A gaming device utilization is greater than or equal to 50%, then activate an event.” One event can be defined as increasing the audio output 3 decibels (db) and increasing the brightness of gaming device lighting by 10% for the zone A gaming devices. The rules database 425 provides a set of instructions that the event controller uses to send a control command or set of control commands to the gaming device management system 470 via path 406 to implement this event. In this case, the event represents a marketing decision designed to increase the appeal of the zone A gaming devices when at least 50% of the devices are being used. As one skilled in the art will appreciate, the rules database 425 can associate multiple levels of event messages and expressions to multiple events (or sets of instructions) that can be sent to a plurality of system entities to implement more complex behaviors. In one embodiment of the present invention, the event controller instruction set includes directives such as conditional and unconditional delays for sequencing the presentation of control commands.

2. Distributing Audio/Video

According to one embodiment of the present invention, the event controller can distribute audio/video 410 to and from the music and paging system 460. One benefit of this feature is location customized messaging. Instead of broadcasting a page through every speaker on the casino floor, the message can be directed to the area of the patron. An affinity card, ticket, transponder, or other devices (e.g., a Harrah's Entertainment TotalRewards card) are used to track patron spending and to incentivize additional patronage by awarding complimentary goods or services (“comps”). When a patron uses his affinity card at a gaming device, the gaming device management system 470 can, therefore, detect the presence of a patron at the particular gaming device. The event controller can leverage the presence information from the gaming device management system 470 to route a page to the patron's current gaming device, the zone of gaming devices, or to the set of house speakers in the region of the gaming device. In the case of a transponder-based affinity system, transceivers can be placed throughout the casino floor to track the patron's location and route an incoming page accordingly.

More specifically, referring again to FIG. 4, the music and paging system 460 sends an event message including a data payload via path 412 to the event controller. The event controller distributes the audio 410 via path 413 by presenting a control command to the gaming devices management system 470. The gaming devices management system 470 routes the control command including a data payload to the gaming device where the patron is playing. At the gaming device, control module receives the control command and parses the data payload. The data is passed to an audio processing unit. In one embodiment, the data payload contains digitally encoded audio information. The gaming device decodes the audio signal and mixes it with the game's audio output. An announcement, such as “Mr. Jones, your wife is waiting for you in the restaurant,” emanates from the gaming device sound system. In another embodiment, the data payload contains an encoded message (e.g., a text string). The gaming device then synthesizes the encoded message to produce an audio signal. The audio signal is mixed with the game's audio and output from the gaming device sound system. One skilled in the art will appreciate that many other variations are possible. For example, on the video product 145, the encoded message can be displayed on the monitor.

In addition, audio from the gaming devices management system 470 or pre-defined audio segments can be distributed to the music and paging system 460. The gaming devices management system 470 can send an event message via path 471 when, for example, a gaming device hits a jackpot. The rules database 425 can be configured to distribute audio/video 410 in response to the event message. One example of an expression that is applicable to this usage mode is “if a zone A jackpot message is received, then activate announcement event for zone A.” The announcement event can include broadcasting a message such as “Another Winner.”

The rules database 425 can also activate an event that broadcasts the audio output of a gaming device through the music and paging system 460. In one example implementation of this feature, when the gaming device hits a jackpot, audio data from the gaming device audio processing unit is marshaled into an event message that is sent along path 471 to the rules database 425. As described above, the rules database 425 can be configured with marketing rules that cause events to occur responsive to event messages. The rules database 425 distributes the audio 410 to the music and paging system 460 in a control command via path 411. The control command instructs the music and paging system 460 to broadcast the audio data to the whole casino floor or a subset of the casino floor, such as the zone of the winning gaming device.

In another example implementation, the data corresponding to the audio output of a winning gaming device can be stored in the rules database 425. This may advantageously reduce the amount of data flow along path 471. One skilled in the art will appreciate that other techniques to reduce messaging overhead or bandwidth consumption may be implemented. One such technique includes configuring the music and paging system 460 to cache audio or video data for subsequent processes or events.

3. Adjusting Lighting

Another event controller usage mode includes adjusting lighting 415. In this usage mode, the event controller sends control commands to the lighting control system 480 via path 416 to adjust the environmental lighting. In an embodiment of the present invention described above, the lighting control system 480 can be instructed to activate a spotlight on a winning player. More specifically, the gaming devices management system 470 informs the rules database 425 of a jackpot by sending an event message via path 471. The rules database 425 can be configured to initiate several events responsive to the event message. The rules database 425 instructs the event controller to send a control command to the lighting control system 480. In this example, the control command includes a location designator, such as a zone and gaming device identifier (e.g., “A101”). The lighting control system 480 receives the control command and activates a spotlight in the designated location. The control command can also include other data fields, such as a time duration for the light. Alternatively, based on other criteria (such as time duration), the event controller can send a second control command to the lighting control system 480 to deactivate the light.

In another embodiment of the present invention, the gaming device management system 470 can send an event message on path 472 to enable a direct lighting adjustment 415. In this case, the event message from the gaming devices management system 470 contains a direct command, such as “enable light A101.” One advantage of the direct command is that it enables distributed control logic. That is, the gaming device control module is able to activate events without depending on logic programmed into another entity (e.g., the rules database 425). The ability to control a light on the casino floor responsive to game play, for example, provides additional flexibility to the gaming device designers that are striving to construct appealing devices. One skilled in the art will appreciate, however, that the event controller can function as a gatekeeper for controlling the behavior of the direct commands.

4. Auxiliary Control

In addition to the usage modes described above, the event controller includes auxiliary control 420. This usage mode enables the event controller to interface with and to operate a broad group of devices that have on/off (e.g., momentary toggle) interfaces. In the embodiment illustrated in FIG. 4, the motor controller 490 is responsive to this type of input. That is, a signal can be asserted on path 421 to activate the motor controller 420 and de-asserted to deactivate the motor controller 420. The motor controller 420 in turns controls a motor driven device (not shown).

In one embodiment of the present invention, the rules database 425 activates an event including auxiliary control 420. Responsive to a jackpot event message from the gaming devices management system 470, the rules database 425 instructs the event controller to assert a signal on path 421 to the motor controller 490. The motor controller 490 operates a motor driven device, for example, a blower fan that inflates a casino mascot. After a predetermined elapse of time or responsive to other criteria, the rules database 425 instructs the event controller to de-assert the signal on path 421 thereby returning the mascot to its deflated position.

As described above, an event message can activate a number of events that use various combinations of the usage modes. For example, in response to a jackpot event message, the rules database 425 can concurrently or sequentially instruct the event controller to broadcast audio, to inflate a casino mascot, to ignite pyrotechnics, to flash the gaming device lighting, and to illuminate the winning player. Many other variations are contemplated. For example, when a gaming device hits a jackpot, it may be desirable to adjust game parameters 405 for other gaming devices in the surrounding area or zone. The gaming device lighting and casino floor lighting in the winning zone could be dimmed to enhance the marketing effect of spotlighting the winning player.

C. Event Controller Architectures

1. First Configuration

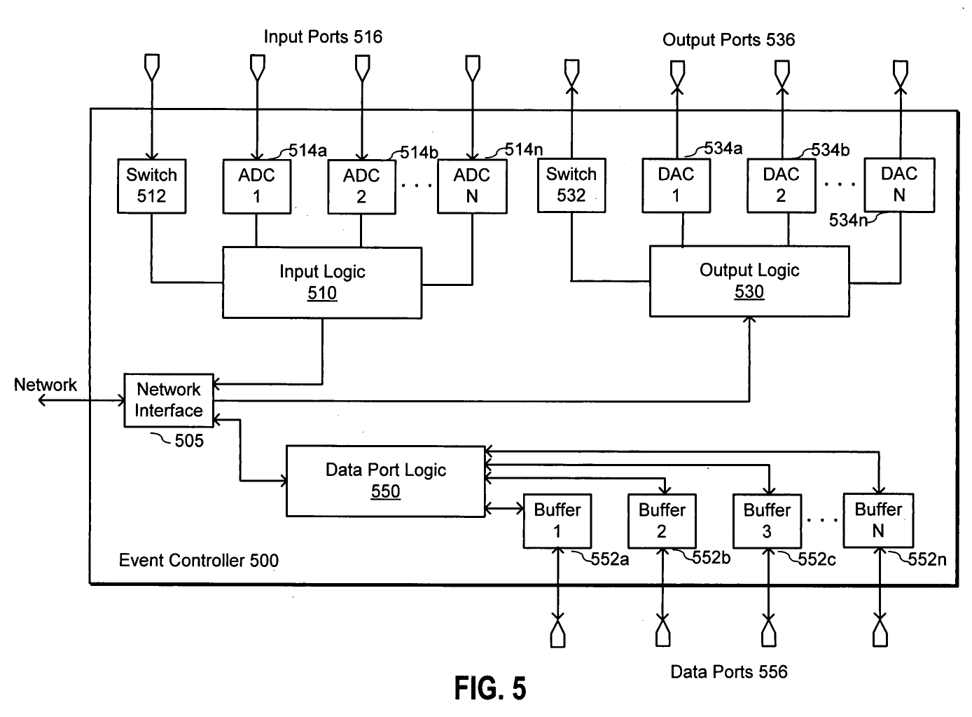

FIG. 5 is a block diagram of an event controller according to one embodiment of the present invention. In the illustrated embodiment, the event controller 500 comprises a network interface 505, input logic 510, output logic 530, and data port logic 550. Each of the input logic 510, the output logic 530 and the data port logic 550 are coupled to the network interface 505. Coupled to the input logic 510 are a switch 512 and a plurality of analog-to-digital converters 514 (a first analog-to-digital converter 514a, a second analog-to-digital converter 514b, and an n^{th} analog-to-digital converter 514n). The switch 512 and the plurality of analog-to-digital converters 514 form a group of input ports 516. The input ports 516 can be coupled to external devices for providing input signals to the event controller 500.

Coupled to the output logic 530 are a switch 532 and a plurality of digital-to-analog converters 534 (a first digital-to-analog converter 534a, a second digital-to-analog converter 534b, and an n^{th} digital-to-analog converter 534n). The switch 532 and the plurality of digital-to-analog converters 534 form a group of output ports 536. The output ports 536 can be coupled to external devices for providing output signals from the event controller 500.

Coupled to the data port logic 550 is a plurality of buffers 552 (a first buffer 552a, a second buffer 552b, and an n^{th} buffer 552n). The plurality of buffers 552 forms a group of data ports 556. The data ports 556 can be coupled to external devices for interfacing digital signals with the event controller 500. The input logic 510, the output logic 530, and the data port logic 550 can be implemented using, for example, a programmable logic device (PLD), a field programmable gate array (FPGA), an application-specific integrated circuit (ASIC), a microcontroller, or a general-purpose processor. One skilled in the art will appreciate that although discrete components are illustrated, an FPGA (e.g., a Virtex-II Pro that is commercially available from Xilinx Inc., San Jose, Calif.) or ASIC can be used to integrate the components physically or functionally.

a) Input Ports

In one embodiment of the present invention, the input ports 516 are coupled to system entities or other external devices. The input ports 516 can be used for sampling signals (e.g., an audio signal) or for interfacing with switching circuits. The switch 512 electrically isolates an input load and provides a binary interface that represents the state (e.g., asserted/de-asserted) of the input load. The plurality of analog-to-digital converters 514 provides a digital representation of analog signals to the input logic 510. The input logic 510 multiplexes and formats the digital data received from the input ports 516 into data frames. The data frames are forwarded to the network interface 505 for network transmission.

The input ports 516 illustrated are an exemplary configuration. For example, although a single switch 512 is illustrated, the event controller 500 can include a plurality of switches (e.g., relays). One skilled in the art will recognize that system entities or external devices that provide a binary analog input (e.g., on/off toggle) can also be coupled to one of the plurality of analog-to-digital converters. However, the switch 512 represents a robust electrical input because it can be designed to handle high current, transient, or erratic loads that may cause an analog-to-digital converter to fail or to perform poorly.

b) Output Ports

In one embodiment of the present invention, the output ports 536 are coupled to system entities or other external devices. The output ports 536 can be used for converting signals (e.g., digital audio) or for output switching. The switch 532 provides an electrically isolated switched output. In response to a binary signal from the output logic 530, the switch 532 changes its state (e.g., asserted/de-asserted). The plurality of digital-to-analog converters 534 provides an analog output signal that can be coupled to an external device or system entity. The output logic 510 parses the data frames received from the network interface 505 and routes the digital signals to the designated output port 536.

The output ports 536 illustrated are an exemplary configuration. For example, although a single switch 532 is illustrated, the event controller 500 can include a plurality of switches (e.g., relays). One skilled in the art will recognize that the digital-to-analog converters can also provide an on/off toggle output to drive an input on a system entity or external device. However, the switch 532 represents a robust electrical output because it can be designed to source the high turn-on currents expected by the output load that may cause a digital-to-analog converter to fail or to perform poorly.

2. Input/Output Operation

The event controller 500 functions in the interactive mode described above. That is, signals are received on the input ports 516, digitized, and sent to a system entity (e.g., the server 130) for processing. When an analog signal is detected and digitized using, for example, the first analog-to-digital converter 514a, the input logic 510 generates an event message including a payload of the digital representation of the analog signal and a data field indicating that the signal corresponds to the first analog-to-digital converter 514a. When the state of the switch 512 changes, the input logic 510 generates a corresponding event message. This event message includes data about the present state of the switch 512. The system entity that receives the event message (e.g., the server 130) can be configured to activate an event responsive to the event message. To activate the event, the system entity sends instructions to the event controller 500. The output logic 530 evaluates the instructions and forms a control command. The control command can include a digital data payload to be converted to the analog domain on the output ports 536.

In one example, the alarm output 107 of the life safety system 105 is coupled to the switch 512. When the life safety system 105 asserts an alarm signal on the alarm output 107, the state of the switch 512 changes. The input logic 510 detects this change, and forwards an event message to the network interface 505. From the network, the server 130 receives the event message. The server 130 is configured with an expression that indicates how to process the event message. An example expression is “if the switch 512 is asserted, then activate interrupt mode.” The server is configured with information about the device coupled to the switch 512 so that an appropriate event can be activated. In this case, the server 130 sends a control command comprising an interrupt signal to the gaming device management system 125. The gaming device management system 125 distributes the interrupt signal to the control module of the gaming devices to attenuate the audio output or halt game play.

In another example, the alarm output 107 of the life safety system 105 is coupled to the first analog-to-digital converter 514a. When the life safety system 105 asserts an alarm signal on the alarm output 107, the input logic 510 detects the digitized signal from the first analog-to-digital converter 514a. The input logic 510 forwards an event message including a data payload to the network interface 505. From the network, the server 130 receives the event message and parses the data payload. The server 130 recognizes that the event message contains a signal from the life safety system 105. When the alarm output 107 is coupled to the switch 512, the server 130 receives a binary data value that indicates whether an alarm signal is asserted or de-asserted. In this example, however, the server 130 receives a digital representation of an analog signal level.

In order to activate an appropriate event, the server 130 identifies whether the digital representation indicates an asserted or de-asserted signal. In one embodiment, the server 130 recalls the digital representation of the last event message and compares the present event message to determine if state change has occurred. In another embodiment, the server 130 is configured with information about the polarity and swing voltage of the alarm signal. The server 130 then compares the digital representation to these characteristics. However, as one skilled in the art will appreciate, the server 130 expects some deviation in the observed signals because of, for example, transmission attenuations, impedance mismatches, or noise.

One advantage of coupling a system entity, such as the life safety system 105, to one or more of the plurality of analog-to-digital converters 514 is that the system entities can be interfaced using coded or modulated signals. Coding the alarm signal, for example, can reduce the chance of false event activation and increase the integrity and the reliability of the system architecture. One skilled in the art will recognize that a simple ground fault or short circuit could cause false event activation on an unprotected interface.

In a further example, the music and paging system 110 is coupled to the event controller 500. The music and paging system 110 includes an analog audio output 112 and an analog audio input 113. The analog audio output 112 is coupled to, for example, the second analog-to-digital converter 514b. The analog audio input 113 is coupled to, for example, the second digital-to-analog converter 534b. The input logic 510 receives audio data, such as a page, from the second analog-to-digital converter 514b. The input logic 510 is configured to forward the audio data to the network interface 505.

The output logic 530 receives a data stream from the network interface 505. The output logic 530 demultiplexes the data stream and routes the data to one or more of the output ports 536. In this example, the data represents audio signals originating from another system entity, such as the audio output of a winning slot product 140. The second digital-to-analog converter 534b provides a corresponding analog audio signal to the music and paging system 110. The music and paging system 110 can then distribute the audio signal through a public address system.

In another embodiment, the music and paging system 110 includes a digital interface. The digital interface can be coupled to one or more of the data ports 556. One advantage of the digital interface is that metadata can be exchanged more easily between the devices. The plurality of buffers 552 couple the data port logic 550 to the data ports 556 for temporary data storage or jitter correction. In one example, the data port logic 550 can send a control command to the music and paging system 110 that includes metadata to describe how the audio data payload should be distributed. This enables the music and paging system 110 to broadcast a message (e.g., “Another Winner!”) to a specific area of the casino floor.

In a further example, the lighting control system 115 is coupled to the first buffer 552a. Responsive to instructions to activate an event, the data port logic 550 can create a control command and forward the command to the first buffer 552a. The first buffer 555a then sends the control command to the digital interface of the lighting control system 115 coupled thereto. To active a spotlight on a particular gaming device, the control command includes a data field for indicating the location of the gaming device or an identifier for the spotlight. One skilled in the art will appreciate that the format and content of the control command can depend on the implementation of the lighting control system 115. The data port logic 550 can implement a capabilities exchange protocol to ascertain the data format expected by the lighting control system 115, for example.

3. Second Configuration

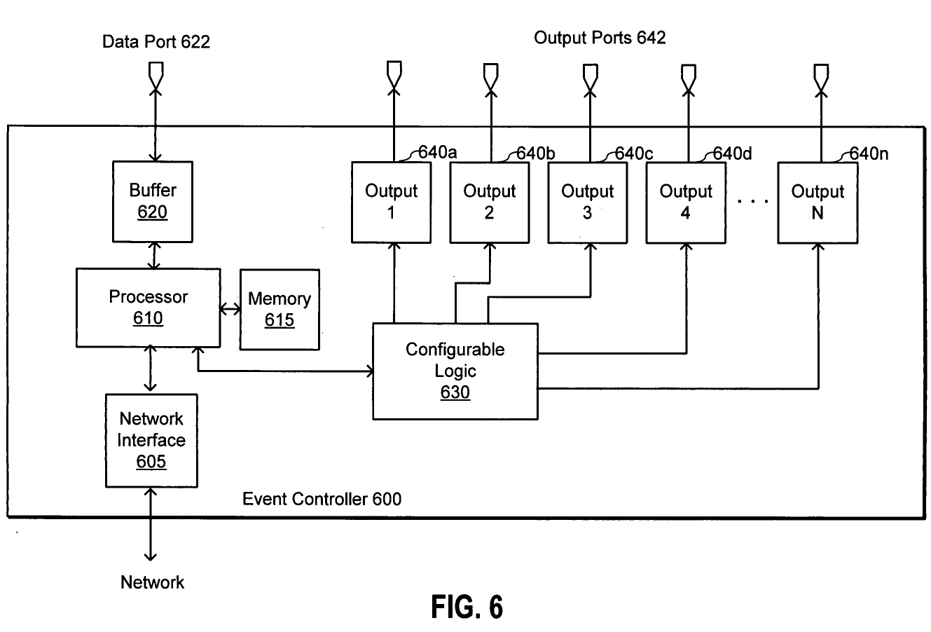

FIG. 6 is a block diagram of an event controller according to another embodiment of the present invention. In the illustrated embodiment, the event controller 600 includes a network interface 605, a processor 610, a memory 615, a buffer 620, and a configurable logic 630. The network interface 605, the memory 615, the buffer 620, and the configurable logic 630 are each coupled to the processor 610. Coupled to the configurable logic is a plurality of output devices 640 (a first output device 640a, a second output device 640b, a third output device 640c, a fourth output device 640d, and an n^{th} output device 640n).

The plurality of output devices forms a group of output ports 642. The output ports 642 can be coupled to external devices for providing output signals from the event controller 600. In one embodiment of the present invention, each of the plurality of output devices 640 is a digital-to-analog converter. One skilled in art will appreciate, however, that the plurality of output devices 640 can be a combination of digital-to-analog converters, switches, relays, digital interfaces, or signal drivers. The configurable logic 630 can route control commands (and included data payload) to each of the plurality of output devices 640 independently. Therefore, command sequences do not block in the processor 610 waiting for the configurable logic 630 to service the plurality of output devices 640.

The buffer 620 couples to a data port 622. The buffer 620 stores data to be sent or that is received from the data port 622. In one embodiment of the present invention, the data port 622 represents a universal serial bus (USB) interconnect. The data port 622 can be used, for example, as an expansion port for the event controller 600. In the illustrated embodiment, the data port 622 interfaces with the processor 610. A device coupled to data port 622 can be used to expand or to enhance the processing capabilities or features of the event controller 600.

The configurable logic 630 provides signals to the plurality of output devices 640. The processor 610 generates control commands, which the configurable logic 630 routes to one or more of the plurality of output devices 640. In one embodiment of the present invention, the processor 610 configures the configurable logic 630 to perform its output functions. One advantage of the configurable logic 630 is that its behavior can be changed to accommodate various configurations of the plurality of output devices 640 or the entities coupled to the output ports 642. Therefore, the configurable logic 630 can be implemented using, for example, a programmable logic device (PLD), or a field programmable gate array (FPGA). In another embodiment, where fewer configuration changes are likely, the configurable logic 630 can be implemented using an application-specific integrated circuit (ASIC), a microcontroller, or a general-purpose processor.

The memory 615 provides data and instruction code for the processor 610. The memory 615 can also be configured to include a rules database. The rules database incorporates expressions that the processor 610 can evaluate responsive to an event message. When evaluation of the expression indicates that an event is to be activated, the processor 610 can forward a control command or a set of control commands to the network interface 605 or the configurable logic 630. The processor 610 forwards the control command to the network interface 605 when the event is to be activated on a system entity coupled to the network. The processor 610 forwards the control command to the configurable logic 630 when the event is to be activated on a system entity coupled to one or more of the output ports 642.

a) Operational Description

The event controller 600 functions in the standalone mode or hybrid mode described above. The event controller 600 can receive event messages from other system entities and determine whether the event message activates a particular event or a set of events. In the illustrated embodiment, the event messages originate from the network interface 605 or the data port 622. For example, the life safety system 240 can send an alarm event message via the network interface 505.

For schedule-based events, the processor 610 can also generate event messages. As described above, a rules database can include calendared events. Examples include promotional messages and gaming device audio level adjustments. Promotional messages can be distributed at particular intervals or times of day via the music and paging system 110 or via the gaming devices management system 125. Gaming device audio level adjustments can also occur at particular times of the day. At 06:00 hours each weekday the event controller 600 can send a control command to the gaming devices to adjust the volume of the audio outputs to a static level or a dynamic level based on, for example, ambient or background noise level. And at 17:00 hours, the event controller 600 can send a control command to increase the audio output.

As described above, a sensor can provide information about the ambient or background noise level present in the gaming facility. The event controller 600 can use information acquired from the sensor to adjust the volume of the gaming devices with respect to the background noise level. In one embodiment of the present invention, the gaming devices management system 125 is configured to store data acquired from the sensor. The event controller 600 can send a control command to the gaming device management system 125 to adjust the volume of the gaming devices 3 decibels (dB) above the stored sensor data.

In another embodiment of the present invention, sensor data that is acquired by a system entity (e.g., the gaming devices management system 125, the zone switch 220, and the event controller 120) is forwarded to the server 130. The server 130 can, therefore, provide the sensor data needed to process sensor-dependent control commands. For example, when making an adjustment the gaming device volume relative to the ambient noise level, the event controller 600 can send a message to the server to request the ambient noise level. The processor 610 then sends a control command to the gaming device management system 125 including an absolute volume level. More specifically, if the ambient noise level is 3 dB and the activated event includes an expression to set the gaming device volume to 3 dB above the ambient noise level, then the event controller 600 sends a control command to the gaming device to adjust the gain control by +6 dB.

D. Gaming Device Architecture

The event controller sends control commands to the gaming device management system 125. The gaming device management system 125 communicates the control commands to the gaming devices, such as the slot product 140 and the video product 145. The gaming device management system 125 also maintains a database for storing data about the operation of the gaming devices. The database can be internal to the gaming device management system 125 or external. In the case of an external database, the server 130, for example, can host the database. One skilled in the art will appreciate that the server 130 can manage the database as a distinct data store or merge the database into another data store.

In one embodiment of the present invention, the gaming device management system 125 includes an event monitor for interfacing with the event controller. The event monitor receives an incoming control command and distributes the control command to the indicated gaming device or zone of gaming devices. In a passive operating mode, the event monitor can parse the control command and place the data into the database of information maintained by the gaming device management system 125. In this mode, control commands are not actively distributed; rather the gaming devices periodically poll for the command. Although the passive mode can be less responsive than the active mode, the passive mode can advantageously reduce bandwidth requirements or place less processing demand on the gaming devices. One skilled in the art will recognize that control commands can be classified according to importance where life safety interrupt commands, for example, are always processed in the active mode.

The gaming device management system 125 also sends event messages to other system entities including the event controller. In one embodiment of the present invention, the gaming device management system 125 includes database procedures that trigger event messages. When a gaming device hits a jackpot, the gaming device informs the gaming device management system 125 of the jackpot event. The gaming device management system 125 records the jackpot in a database. When the data record is updated, for example, a database procedure is triggered to generate an event message. In one example, the event message is sent to the event controller 120, which is programmed to send a control command to the lighting control system 115.

1. Game Board

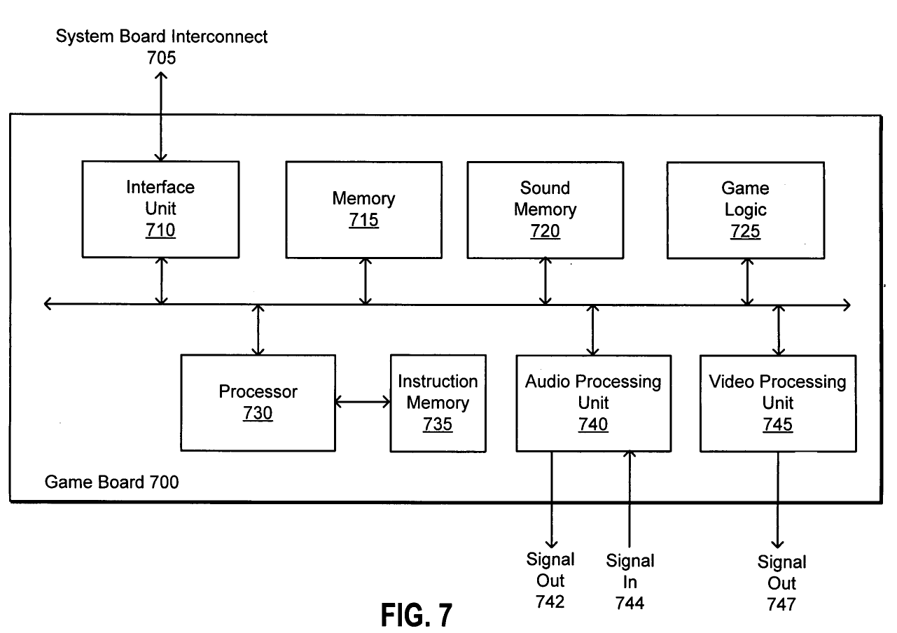

FIG. 7 is a block diagram of a game board according to one embodiment of the present invention. A gaming device, such as the video product 145, includes a game board 700. The game board 700 interfaces with a system board (not illustrated) via a system board interconnect 705. The system board couples the gaming device to the gaming device management system 125 and includes software or hardware, such as a network protocol stack, for communicating data with the gaming device management system 125. In the illustrated embodiment, a game board 700 includes the following modules: an interface unit 710, a memory 715, a sound memory 720, a game logic 725, a processor 730, an instruction memory 735, an audio processing unit 740, and a video processing unit 745. Each of the modules is coupled to a bus 750 for transferring data among the modules. In a gaming device without video display features, such as the slot product 140, the game board 700 need not include the video processing unit 745. Although the modules of the game board 700 are illustrated in FIG. 7 as distinct functional blocks, one skilled in the art will appreciate that the functionalities of the modules need not be implemented in distinct software or hardware.

The interface unit 710 manages data flow via the system board interconnect 705. The interface unit 710 determines whether the data on the bus 750 should be sent to the system board for transmission to the gaming device management system 125. Likewise the interface unit 710 places data originating from the system board (e.g., control commands from the gaming device management system 125) onto the bus 750.

The memory 715 represents a conventional data storage device. In one embodiment, the memory 715 stores control commands. The sound memory 720 is provided for storing digital audio data. The digital audio data includes messages such as “Welcome to Harrah's Casino” that can be programmatically played back. For example, the event controller 120 can send a control command that triggers message playback. Further, the event controller can send messages for storage to the sound memory 720. In addition, a control command can include a customized digital audio payload that is played back in conjunction with a stored message. Using the above example, when Mr. Jones, a casino patron, inserts his affinity card into the gaming device, the gaming device management system 125 can alert the event controller 120 of Mr. Jones' presence. An expression can be defined to activate a welcome message event. Accordingly, the event controller 120 sends a control command to play back a greeting including a digital representation of Mr. Jones's name. The gaming device then responds, for example, “Nice to see you again, Mr. Jones.” The digital representation of Mr. Jones's name can be, for example, digital audio or instructions for speech synthesis.

The game logic 725 performs the random number generation and associated functions that implement the game play. The processor 730 coordinates data transfer among the modules. The processor 730 also decodes or parses the control commands and implements the corresponding functions. The processor 730 couples to an instruction memory 735, which stores program code. The instruction memory 735 can be a field programmable memory device, such as a flash RAM device. One advantage of the instruction memory 735 being field programmable is that the program code can be changed remotely. For example, the gaming device management system 125 can download program code to the game board 700 to change the operation of the processor 730, or to implement new features.

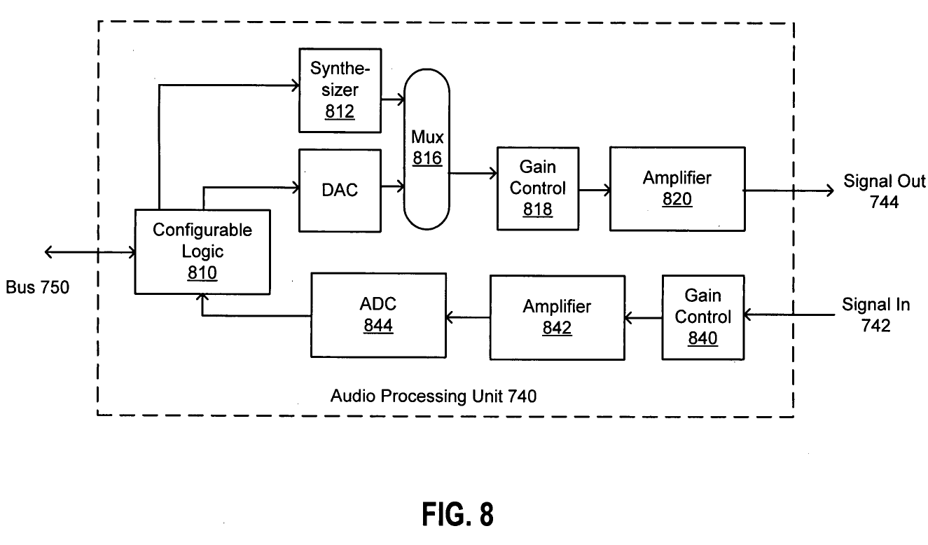

The audio processing unit 740 includes a signal output 742 and a signal input 744. The audio processing unit 740 manages the audio output of the gaming device. For example, the game logic 725 places game play-related audio on the bus 750. The audio processing unit 740 receives the audio data from the bus 750 and outputs the audio to a speaker system. Further details of the audio processing unit 740 are described below and with reference to FIG. 8.

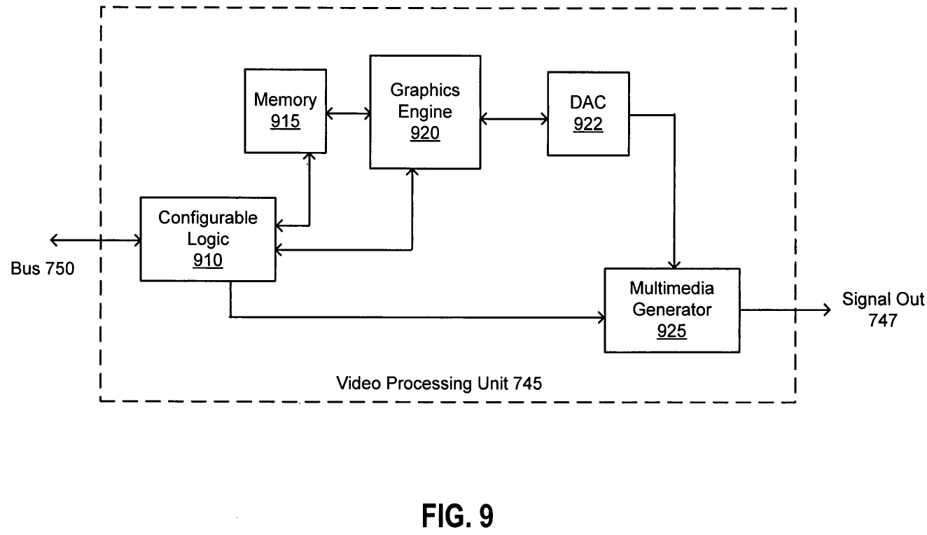

If the gaming device includes video features, the video processing unit 745 manages the video display. For example, the game logic 725 can send graphics or multimedia content to the video processing unit 745 via the bus 750. The video processing unit 745 includes a signal output 747 that can be coupled to a video monitor. If the gaming device has multiple video displays, additional instances of the video processing unit 745 can be coupled to the bus 750. In this case, each of the video processing units 745 is used to drive one video display. Further details of the video processing unit 745 are described below and with reference to FIG. 9.

2. Audio Processing

FIG. 8 is block diagram illustrating an audio processing unit of a game board according to one embodiment of the present invention. The audio processing unit 740 includes configurable logic 810 that is coupled to the bus 750. The configurable logic 810 implements a conventional bus arbitration protocol to manage data transfers to/from the bus 750. The configurable logic 810 also manages two concurrent data flows or signal paths (i.e., the signal input 742 and the signal output 744) and corresponding control signals.

a) Output Signal Path

On the output path, the configurable logic 810 couples to a synthesizer 812 and a digital-to-analog converter 814. The synthesizer 812 uses frequency modulation, instrument samples, or digital signal processing, for example, to produce an analog audio output signal. The digital-to-analog converter 814 produces an analog signal from a digital signal. Each of the synthesizer 812 and the digital-to-analog converter 814 couple to a multiplexer 816. The multiplexer 816 selects the output signal from one of the synthesizer 812 and the digital-to-analog converter 814, or combines the outputs into a composite signal. The configurable logic 810 controls the operation of the multiplexer 816.

In one embodiment of the present invention, the synthesizer 812 creates game play-related audio. The game logic 725 instructs the synthesizer 812 to create audio signals, such as music. In addition, the synthesizer 812 can be configured to synthesize a human voice. The digital-to-analog converter 814 can be used to produce sounds from digital data, such as the audio data stored in the sound memory 720.

From the multiplexer 816, the audio signal is input to a gain control 818. The gain control 818 adjusts the amplitude of the audio signal in response to a control signal from the configurable logic 810. When the game board 700 receives a control command to adjust the gaming device volume, the processor 730 instructs the audio processing unit 740 to adjust the gain control 818. The configurable logic 810 sets the gain control 818 to the requested volume level. In one embodiment of the present invention, the gain control 818 is a voltage-controlled attenuator. The configurable logic 810 controls the attenuation by changing a voltage level. In another embodiment of the present invention, the gain control 818 is a programmable signal attenuator. The configurable logic 6810 sets the attenuation by digital control.

After the gain control 818, the audio signal is input to an amplifier 820. The amplifier 820 can have fixed or variable gain. The output of the amplifier 820 provides the signal output 744, which is typically coupled to a speaker or set of speakers. One or both of the gain control 818 and the amplifier 820 can be adjusted depending on the desired gaming device volume.

b) Input Signal Path

The audio processing unit 740 also includes an input signal path. In one embodiment of the present invention, the sensor 142 is coupled to the signal input 742. The sensor 142 detects environmental conditions, such as background noise. The signal input 742 is applied to a gain control 840. Under the control of the configurable logic 810, the gain control 840 attenuates the signal input 742 if needed. The configurable logic 810 can determine whether to attenuate the signal input 742 using the gain control 840 by examining the output of the analog-to-digital converter 844. An amplifier 842 amplifies the signal from the gain control 840. The amplifier 842 feeds the analog-to-digital converter 844. The amplifier 842 can adjust the signal to enable the analog-to-digital converter 844 to produce an accurate digital representation of the signal input 742. The output of the analog-to-digital converter 844 is coupled to the configurable logic 810.

In one embodiment of the present invention, the processor 730 instructs the configurable logic 810 to sample periodically the output of the analog-to-digital converter 844. In another embodiment of the present invention, the configurable logic 810 signals the processor 730 when the magnitude of the signal input 742 exceeds a predetermined threshold or changes by a predetermined amount within a time period. When the sensor 142 is coupled to the signal input 742, a change in the magnitude of the signal input 742 indicates a corresponding change in the environmental conditions. The processor 730 can then report the change in sensor data to an appropriate system entity (e.g., the gaming devices management system 125 or the server 130).

3. Video Processing

FIG. 9 is a block diagram illustrating a video processing unit of a game board according to one embodiment of the present invention. The video processing unit 745 includes configurable logic 910 that is coupled to the bus 750. The configurable logic 910 implements a conventional bus arbitration protocol to manage data transfers to/from the bus 750. The configurable logic 910 is further coupled to a memory 915, a graphics engine 920, and a multimedia generator 925. The game logic 725 provides video data related to the game play. The processor 730 can also generate video data, such as text or graphics. For example, the game board 700 can receive a control command from the event controller to overlay a text message such as “Welcome to Harrah's Casino!” on the video display. The processor 730 sends video data to the video processing unit 745. The configurable logic 910 forwards the video data to the graphics engine 920. The graphics engine 920 creates the video image that is displayed. The memory 915 can function as a frame buffer for the graphics engine 920. The configurable logic 910 can also store video data in the memory 915. Because the graphics engine 920 produces a digital representation of the video image, the digital-to-analog converter 922 converts the video image to an analog signal that is suitable for a display device (e.g., a conventional television or computer monitor).

The configurable logic 910 can also provide data to the multimedia generator 925. The multimedia generator 925 generates video image overlays with text or graphics. Alternatively, overlays can be processed by the graphics engine 920. The multimedia generator 925 provides the signal output 747, which is coupled to the display device. If the display device includes a digital video interface (e.g., a DVI-compliant display), the configurable logic 910 can send digital data from the memory 915 or the graphics engine 920 to the multimedia generator 925. The multimedia generator 925 can then output a digital signal to a digital video interface.

E. System Communications Protocol

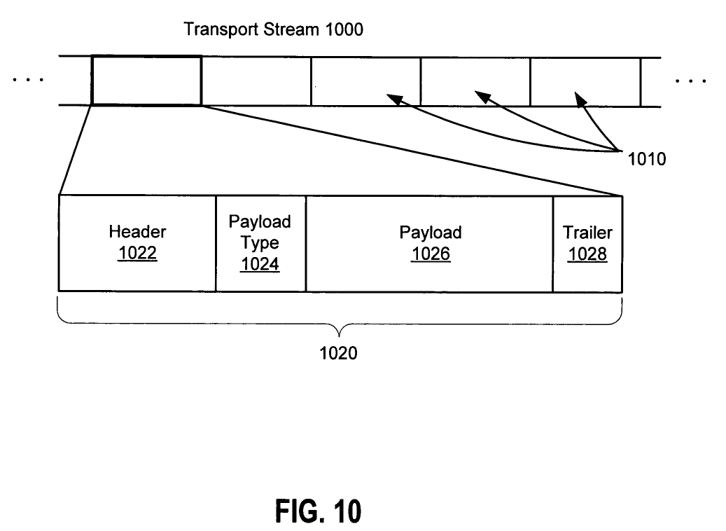

A system communications protocol provides a common framework that the each of the system entities can use for exchanging messages and other data. FIG. 10 is an illustration of a data structure in a transport stream according to one embodiment of the present invention. The transport stream 1000 includes a plurality of timeslots 1010. Each of the timeslots includes a data structure. An exemplary data structure 1020 is shown. The data structure 1020 includes several data fields: a header 1022, a payload type 1024, a payload 1026, and a trailer 1028.

The header 1022 indicates the source and destination system entities. In one embodiment of the present invention, each system entity is distinctly addressable. That is, each system entity has an identifier that is unique with the system configuration. Therefore, the gaming device management system 125 can send an event message to the event controller 120 without affecting communications with the server 130. Further, in a system configuration including a plurality of event controllers, each event controller can be distinctly addressed by the other system entities. This ensures well-defined and reliable event activation.

The payload type 1024 indicates the type of message included in the payload 1026. Several payload types are defined, such as an event message, a control command, a configuration command, raw data, and structured data (e.g., XML). In addition, the payload type 1024 can indicate the priority of the payload 1026. For example, in response to a life safety alarm, the event controller 120 sends a high-priority control command to the gaming devices management system 125. The gaming device management system 125 examines the payload type 1024 and processes the payload 1026 accordingly.

The payload type 1024 can also indicate an adaptation in the payload 1026. One example of an adaptation is a user-defined payload 1026. The event controller client 134, for example, can be configured to send a user-defined message to the event controller 120.

The trailer 1028 contains an uncommon bit sequence that is used to signal the end of the timeslot. A system entity can use the uncommon bit sequence to adjust its internal clocking to synchronize to the transport stream 1000. Once the system entity is synchronized, it can send and receive data on the transport stream 1000.

F. Methods

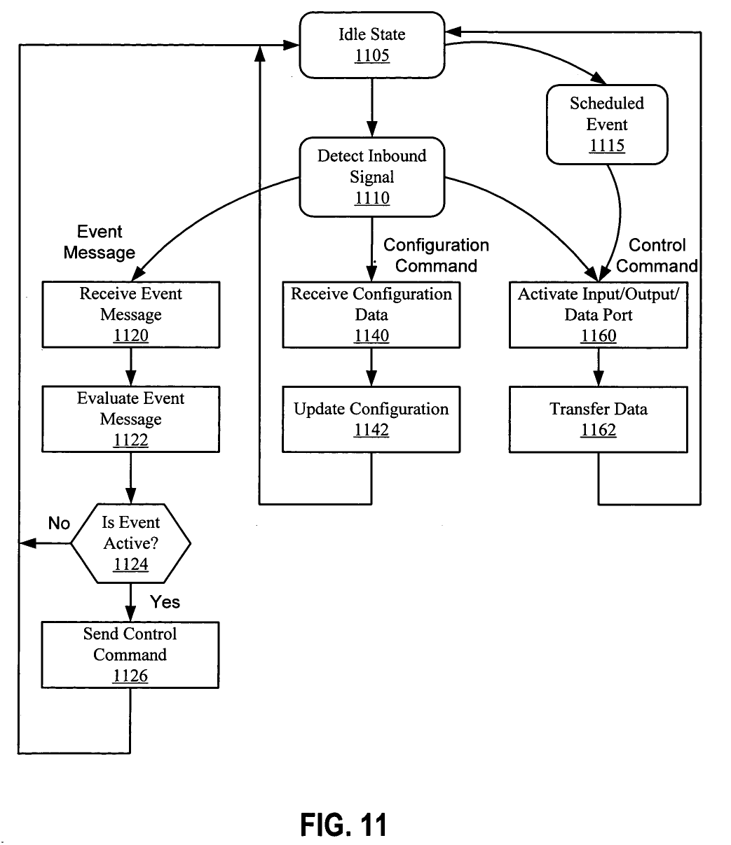

FIG. 11 is a flowchart illustrating event processing according to one embodiment of the present invention. In the illustrated method, the event processing begins in an idle state 1105. From the idle state 1105, the system entity detects an inbound signal 1110 or determines a pending scheduled event 1115. Inbound signals include event messages, configuration commands, and control commands. As described above, an event controller operating in an interactive mode does not receive event messages directly. Rather, another system entity handles the event message and instructs the event controller to execute control commands.

When an event message is detected 1110, control proceeds to receive the event message 1120. The event message is evaluated 1122 to determine if an event should be activated 1124. If an event is triggered, then one or more control commands 1126 are sent to instruct a system entity to activate the event. If an event is not triggered, then control return to the idle state 1105.

More specifically, by way of example, the event controller receives an event message 1120 when a gaming device hits a jackpot. The event message is evaluated 1122 to determine how to process the event message. In this example, the event controller is instructed to activate an output port, which will cause a casino mascot to inflate. The event controller sends a control command 1126 to activate the appropriate output port. After sending the control command, control returns to the idle state 1105. One skilled in the art will recognize that if the event controller is sending a control command to itself, the control command is processed when the event controller returns to the idle state 1105.

When a configuration command is detected 1110, control proceeds to receive the configuration data 1140. Configuration data includes expressions to be stored in a rules database, configuration information for the input logic 510, the output logic 530, the data port logic 550, program code for the processor 610, or the configurable logic 630. After the configuration data is received 1140, the configuration is updated 1142. Updating the configuration includes programming flash RAM devices, configuring FPGAs, or storing data to memory. After the configuration is updated 1142, control returns to the idle state 1105.

When a control command is detected 1110, control proceeds to activate a port 1160. In addition, responsive to a pending scheduled event 1115, control proceeds to activate a port 1160. A combination of input, output, or data ports can be activated. A control module then initiates a data transfer 1162 on the activated port or ports. One example data transfer 1162 is receiving audio data from the music and paging system 110. Another example data transfer 1162 is sending a command to the lighting control system 115. When the data transfer 1162 is completed, control returns to the idle state 1105.

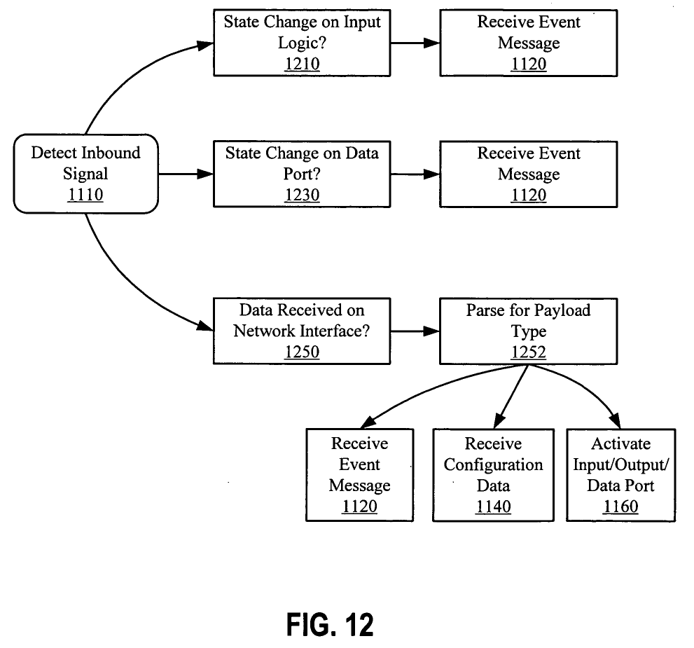

FIG. 12 is a flowchart illustrating further details of detecting an inbound signal 1110 according to one embodiment of the present invention. The process of detecting an inbound signal 1110 includes three concurrent steps: detecting a state change on the input logic 1210, detecting a state change on a data port 1230, and detecting a state change on the network interface 1250.

A state change on the input logic 510 indicates that an external device coupled to one of the plurality of input ports 516 is generating an event message. When a state change is detected 1210, control returns to receiving an event message 1120 with a parameter that indicates which of the plurality of input ports 516 have inbound event messages. Similarly, when a state change is detected 1230 on the data port logic, control returns to receiving an event message 1120 with a parameter that indicates which of the plurality of data ports 556 have inbound event messages.

When an event controller receives messages via the network interface 505, 605, the event controller first determines the type of message. Depending on the type of the message, the event controller can perform different functions. When a data packet is received on the network interface 1250, the data structure 1020 is parsed 1252 for the payload type 1024. As described above, the payload type 1024 indicates the type of message included in the data structure 1020. Depending on the payload type 1024, control proceeds to receive an event message 1120, receive configuration data 1140, or process a control command 1160.

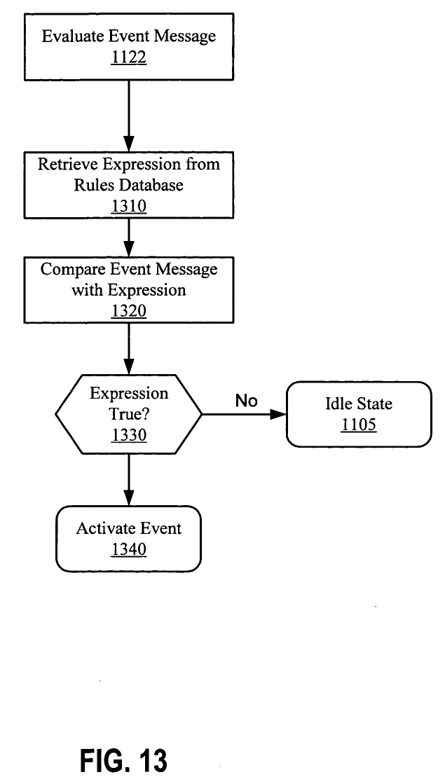

FIG. 13 is a flowchart illustrating further details of evaluating an event message 1122 according to one embodiment of the present invention. The process of evaluating an event message 1122 begins with retrieving an expression from a rules database 1310. As described above, a rules database includes event messages, expressions, and corresponding control commands. An example expression for a jackpot event message is “If jackpot on zone B, then announce ‘Another Jackpot!’ every 6 minutes for the next hour.” Next, the event message is compared 1320 with the expression. The comparison 1320 checks each of the conditions of the expression against the parameters included in the event message. If the expression is satisfied 1330, then an “activate event” state 1340 is set for subsequent processing. If the expression is not satisfied, then no event is activated and control returns to the idle state 1105.

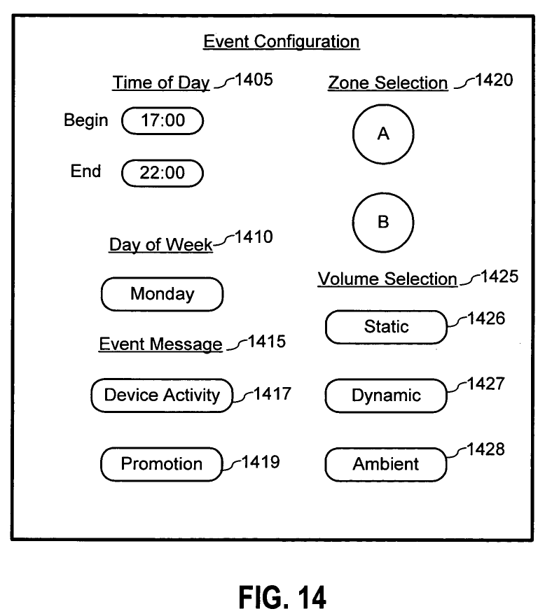

FIG. 14 is a diagram of an exemplary event configuration user interface according to one embodiment of the present invention. The event controller client 134 provides, for example, an interactive or a passive user interface through which a user can configure or monitor the event controller 120. In FIG. 14, there is shown one example of the event controller client 134 user interface for configuring an event.

In the illustration, a user can select how the event is to be activated: by time of day 1405, day of the week 1410, or an event message 1415. A device activity 1417 relates to the number of gaming device in current use. A promotion 1419 relates to a promotional event message that can originate from, for example, the server 130. One type of promotional event is raising the volume of a particular zone of gaming devices to attract more attention to the zone.

Once one of time of day 1405, day of week 1410, or event message 1415 is selected, the user then makes a zone selection 1420. The zone selection 1420 identifies the zone of gaming devices for which the event applies. Volume selection 1425 is the event type. That is, each of the other illustrated parameters are criteria that define the expression that is used to evaluate whether to activate the volume selection 1425 event. The user can select from several types of volume adjustments: static 1426, dynamic 1427, and ambient 1428. The static 1426 option sets the volume (i.e., gain) of the selected zone to a particular value, for example, 10 dB. The dynamic 1427 option raises or lowers the volume a selectable amount from its current setting. For example, the user can select the dynamic 1427 option and then input −3 dB. When the event is triggered, the volume will be lowered −3 dB from its current setting. The ambient 1428 option raises or lowers the volume a selectable amount above or below the background noise level. For example, the user can select the ambient 1428 option and then input +3 dB. When the event is triggered, the volume will be raised +3 dB above the nominal background noise level.

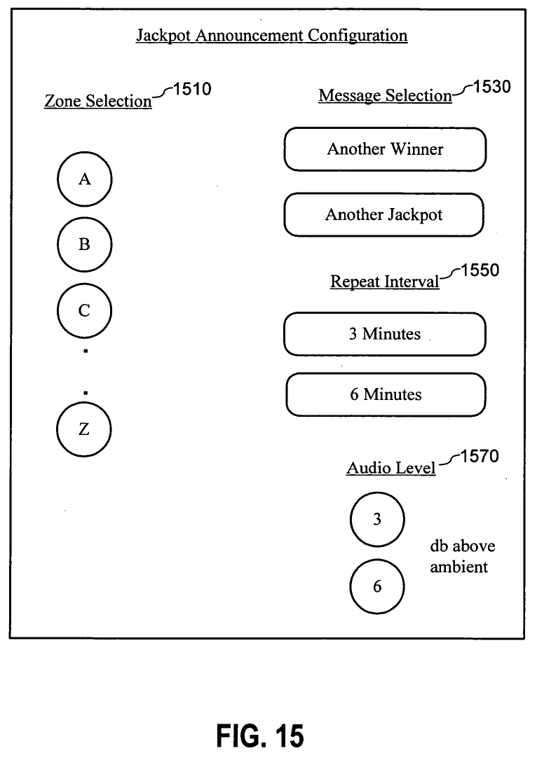

FIG. 15 is a diagram of an exemplary message announcement user interface according to one embodiment of the present invention. In FIG. 15, there is shown one example of the event controller client 134 user interface for jackpot announcement configuration. A jackpot announcement event can be configured occur each time a gaming device hits a jackpot. The user first makes a zone selection 1510. After selecting a zone, the user makes a message selection 1530 for the selected zone. Two messages are shown for clarity of illustration. One skilled in the art will appreciate that many messages can be defined and selected. In the illustrated embodiment, these messages are broadcast via the gaming device in the zone where the jackpot occurred.

The user can also select a repeat interval 1550. The repeat interval 1550 defines how often the jackpot announcement is broadcast. In addition, the user can select an audio level 1570 for the message. In the illustrated embodiment, the audio level is defined in terms of the ambient or background noise level. Jackpot announcement messages provide a marketing or customer service benefit because casino patrons are more likely to play gaming devices when others are winning. Broadcasting the message above the background noise ensures that casino patrons hear the jackpot announcement, thereby increasing the appeal of the gaming devices.

The present invention has been described in particular detail with respect to various possible embodiments. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the feature of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

The present invention is well-suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

1. A casino emergency management system for controlling a plurality of networked gaming devices, the system comprising:
a life safety system including an alarm output for generating an alarm signal in response to a life safety event; and
an event controller including an input module communicatively coupled to receive the alarm signal, and for generating and transmitting an interrupt signal to the plurality of networked gaming devices, wherein each of the plurality of networked gaming devices includes an audio processing unit coupled to a control module, the control module for receiving the interrupt signal from the network and for interrupting the audio processing unit responsive to the interrupt signal.

2. The system of claim 1, wherein the interrupt signal comprises one of an attenuation signal or a system halt signal.

3. The system of claim 1, further comprising a wireless interface for coupling the event controller and the alarm output of the life safety system.

4. The system of claim 1 further comprising an audio system coupled to the event controller, to receive an audio signal from the event controller and output the audio signal in a gaming facility containing the plurality of gaming devices.

5. The system of claim 1, wherein the event controller further comprises a rule base for storing a plurality of rules, each rule defining an event condition and an event output, the event controller activating the event output for a rule on detection of the event condition.

6. The system of claim 1, wherein the event controller further comprises a scheduling module for storing a time based schedule of events, wherein in response to the time of a scheduled event, the event controller generates an event message for controlling a plurality of gaming devices.

7. The system of claim 1, further comprising an environmental sensor for sensing a condition of a gaming facility containing the plurality of gaming devices, and coupled to the event controller for providing the sensed condition to the input module of the event controller, the event controller configured to determine whether to activate an event in response to the sensed condition.

8. The system of claim 1, further comprising a gaming devices management system coupled to the plurality of gaming devices to receive gaming data therefrom and provide control information thereto, the gaming devices management system further coupled to the input module of the event controlling to provide gaming data to the event controller, and to receive an event message from the event controller to control a plurality of gaming devices.

9. The system of claim 8, wherein the gaming devices are configured into a plurality of zones, and the event message instructs the gaming devices management system to control the operation of the gaming devices in at least one zone in response to an event determined by the event controller.

10. The system of claim 9, further comprising in each zone, an environmental sensor for sensing a condition in the zone, and coupled to the event controller for providing the sensed condition to the input module of the event controller, the event controller configured to send an event message to the gaming devices management system in response to the sensed condition in the zone.

11. The system of claim 9, wherein at least one zone is defined by a logical grouping of gaming devices.

12. The system of claim 8, wherein the event message from the event controller signals the gaming devices management system to adjust gaming parameters of at least one gaming device.

13. The system of claim 8, wherein the event message from the event controller signals the gaming devices management system to adjust at least one of an audio output or a video output of each of a plurality of gaming devices.

14. The system of claim 8, wherein the event message from the event controller signals the gaming devices management system to adjust at least one of an audio output or a video output of each of a plurality of gaming devices in response to a predetermined percentage of utilization of the plurality of gaming devices.

15. The system of claim 8, wherein the event message from the event controller signals the gaming devices management system to adjust a denomination of at least one gaming device.

16. The system of claim 8, wherein the event message from the event controller signals the gaming devices management system to adjust a pay table of at least one gaming device.

17. The system of claim 8, wherein the event message from the event controller signals the gaming devices management system to adjust a hold percentage of at least one gaming device.

18. The system of claim 8, wherein the event message from the event controller signals the gaming devices management system to adjust a game selection of at least one gaming device.

19. The system of claim 8, wherein the gaming data received from the gaming devices management system comprises data identifying a patron present at a gaming device, and the event message from the event controller signals the gaming devices management system to transmit at least one of an audio message signal or a video message signal to the gaming device that the patron is present, the message signal output by the gaming device.

20. The system of claim 8, wherein the gaming data received from the gaming devices management system comprises data identifying a winning event at a gaming device, and the event message from the event controller signals an audio system to output an audio message in proximity to the gaming device announcing the winning event.

21-64. (canceled)
